(19) United States
(12) Patent Application Publication
(10) Pub. No.: US 2007/0006310 A1
(43) Pub. Date: Jan. 4, 2007

(54) Systems and methods for identifying malware distribution sites

(76) Inventor: Paul L. Piccard, Longmont, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/171,924

(22) Filed: Jun. 30, 2005

(51) Int. Cl. G06F 12/14

(52) U.S. Cl. 726/24

(57) ABSTRACT

Systems and methods for identifying malware distribution sites are described. In one embodiment, a system includes a malware detection module configured to analyze a file of a protected computer to determine that the file is associated with malware. The system also includes a Web site identification module configured to search a download history log of the protected computer to identify a Web site from which the file was downloaded.

### FIELD OF THE INVENTION

The invention relates generally to computer system management. In particular, but not by way of limitation, the invention relates to systems and methods for identifying malware distribution sites.

### BACKGROUND OF THE INVENTION

Personal computers and business computers can be vulnerable to attack by computer programs such as keyloggers, system monitors, browser hijackers, dialers, Trojans, spyware, and adware, which are collectively referred to as “malware” or “pestware.” Malware typically operates to collect information about a person or an organization—often without the person's or the organization's knowledge. In some instances, malware also operates to report information that is collected about a person or an organization. Some malware is highly malicious. Other malware is non-malicious but may nevertheless raise concerns with privacy or computer system performance. And yet other malware is actually desired by a user.

Techniques are currently available to detect and remove malware. But as malware evolves, techniques for detecting and removing malware should also evolve. Accordingly, current techniques for detecting and removing malware are not always satisfactory and will likely not be satisfactory in the future. Current techniques for detecting and removing malware often use definitions of known malware to scan files of a protected computer. However, it is often difficult to initially locate malware in order to generate the definitions, particularly since malware can evolve. In particular, it would be desirable to identify sources of malware, such that definitions can be generated or updated to account for evolving malware. In addition, identification of sources of malware would allow a blacklist of Web sites to be generated.

Current techniques for identifying sources of malware often involve a centralized system that crawls the Internet to identify Web sites that may be linked to malware. Such a centralized system can be inefficient for a number of reasons. In particular, certain inefficiencies of such a centralized system follow from its centralized nature. In addition, crawling the Internet can be a somewhat haphazard process. As a result, Web sites that do not, in fact, distribute malware may be targeted for evaluation, while Web sites that, in fact, distribute malware may be overlooked. Accordingly, systems and methods are needed to address the shortfalls of current techniques and to provide other new and innovative features.

### SUMMARY OF THE INVENTION

Embodiments of the invention include systems of managing malware. In one embodiment, a system includes a malware detection module configured to analyze a file of a protected computer to determine that the file is associated with malware. The system also includes a Web site identification module configured to search a download history log of the protected computer to identify a Web site from which the file was downloaded.

Embodiments of the invention also include computer-readable media. In one embodiment, a computer-readable medium includes executable instructions to compare a file with a set of malware definitions. The computer-readable medium also includes executable instructions to, based on determining that the file matches one of the set of malware definitions, determine a Web address from which the file was received. The computer-readable medium further includes executable instructions to generate an indication that the Web address is associated with malware.

Embodiments of the invention further include methods of identifying malware distribution sites. In one embodiment, a method includes analyzing a file to determine that the file includes potential malware. The method also includes searching a download history log to identify a Web site from which the file was downloaded. The method further includes generating an indication that the Web site corresponds to a potential malware distribution site.

Other embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a computer system that is implemented in accordance with an embodiment of the invention.

FIG. 2 illustrates a flowchart for identifying a malware distribution site, according to an embodiment of the invention.

### DETAILED DESCRIPTION

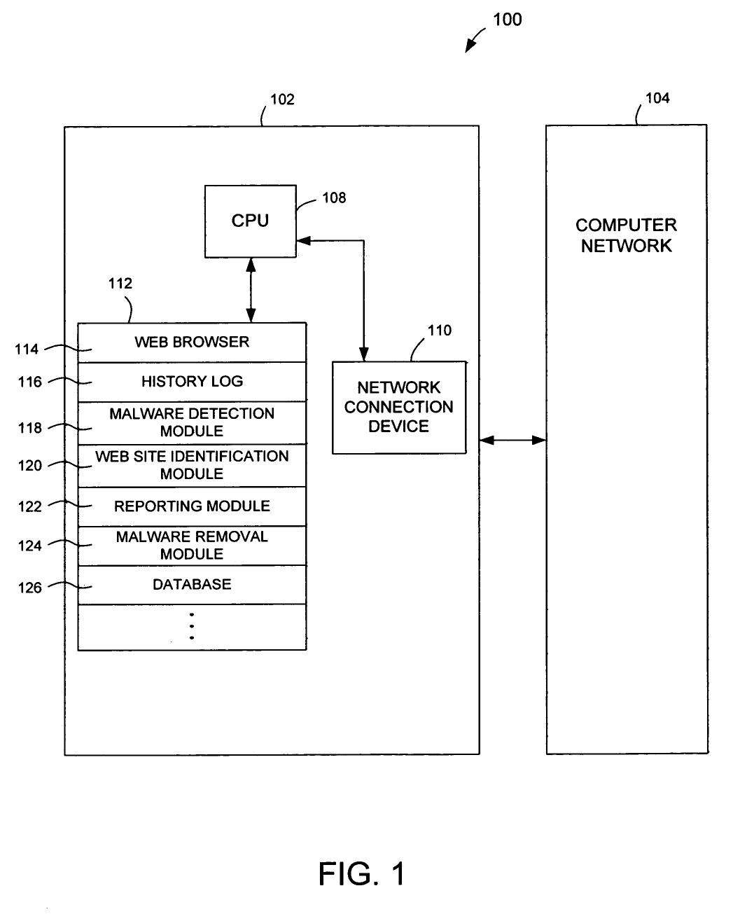

FIG. 1 illustrates a computer system 100 that is implemented in accordance with an embodiment of the invention. The computer system 100 includes at least one protected computer 102, which is connected to a computer network 104 via any wire or wireless transmission channel. In general, the protected computer 102 can be a client computer, a server computer, or any other device with data processing capability. Thus, for example, the protected computer 102 can be a desktop computer, a laptop computer, a handheld computer, a tablet computer, a personal digital assistant, a cellular telephone, a firewall, or a Web server. In the illustrated embodiment, the protected computer 102 is a client computer and includes conventional client computer components, including a Central Processing Unit (“CPU”) 108 that is connected to a network connection device 110 and a memory 112.

As illustrated in FIG. 1, the memory 112 stores a number of computer programs, including a Web browser 114. The Web browser 114 operates to establish communications with the computer network 104 via the network connection device 110. In particular, the Web browser 114 is operated by a user who accesses and downloads files from various Web sites included in the computer network 104. Examples of files that can be downloaded include Web pages, data files, text files, documents, spreadsheets, image files, audio files, Musical Instrument Digital Interface (“MIDI”) files, video files, batch files, and files including computer programs. As illustrated in FIG. 1, the memory 112 also stores a history log 116, which is maintained by the Web browser 114 to provide a record of browsing events. In particular, when a file is accessed and downloaded, the Web browser 114 records a Web address of the file in the history log 116. A Web address typically specifies a location of a file within a Web site. For example, a Web address can be a Uniform Resource Identifier (“URI”) of a file, such as a Uniform Resource Locator (“URL”) of the file. It is also contemplated that a Web address can be defined in various other ways, such as using an Internet Protocol (“IP”) address or any other identifier of a source of a file.

In the illustrated embodiment, the memory 112 also stores a set of computer programs that implement the operations described herein. In particular, the memory 112 stores a malware detection module 118, a Web site identification module 120, a reporting module 122, and a malware removal module 124. As further described below, the various modules 118, 120, 122, and 124 operate to manage malware that can be present in the computer system 100. Referring to FIG. 1, the various modules 118, 120, 122, and 124 operate in conjunction with a database 126, which includes information related to malware. In particular, the database 126 includes a set of malware definitions to allow for detection of malware. As illustrated in FIG. 1, the database 126 also includes a list of malware distribution sites to alert a user about Web sites that are known to distribute malware or that are suspected of distributing malware. The database 126 can be implemented as, for example, a relational database in which information is organized using a set of tables.

As illustrated in FIG. 1, the malware detection module 118, the Web site identification module 120, and the reporting module 122 operate to facilitate identification of malware distribution sites. In particular, once a file is downloaded using the Web browser 114, the malware detection module 118 analyzes the file to determine whether the file includes potential malware. If the file is determined to include potential malware, the Web site identification module 120 determines a Web address from which the file was received. In particular, the Web site identification module 120 accesses the history log 116 to identify the Web address of the file. In such manner, the Web site identification module 120 can identify a Web site from which the file was downloaded and, thus, can identify the Web site as a potential malware distribution site. The reporting module 122 then reports this information to a remotely-located computer that is included in the computer network 104. This information as well as any additional relevant information can be analyzed at the remotely-located computer to determine whether the potential malware is, in fact, malware and whether the Web site is, in fact, a malware distribution site.

As illustrated in FIG. 1, the malware removal module 124 operates to remove or quarantine malware that is downloaded from the computer network 104. In particular, once the malware detection module 118 determines that a file includes potential malware, the malware removal module 124 removes the file or quarantines the file pending confirmation of whether the potential malware is, in fact, malware.

Advantageously, the illustrated embodiment improves the efficiency at which malware distribution sites can be identified. In particular, since the computer system 100 can include additional protected computers that are implemented in a similar fashion as the protected computer 102, certain efficiencies of the illustrated embodiment follow from its decentralized nature. In addition, the illustrated embodiment allows targeted evaluation of Web sites that may be linked to malware. As a result, Web sites that do not distribute malware can be omitted from evaluation, while Web sites that distribute malware or likely distribute malware can be targeted for evaluation.

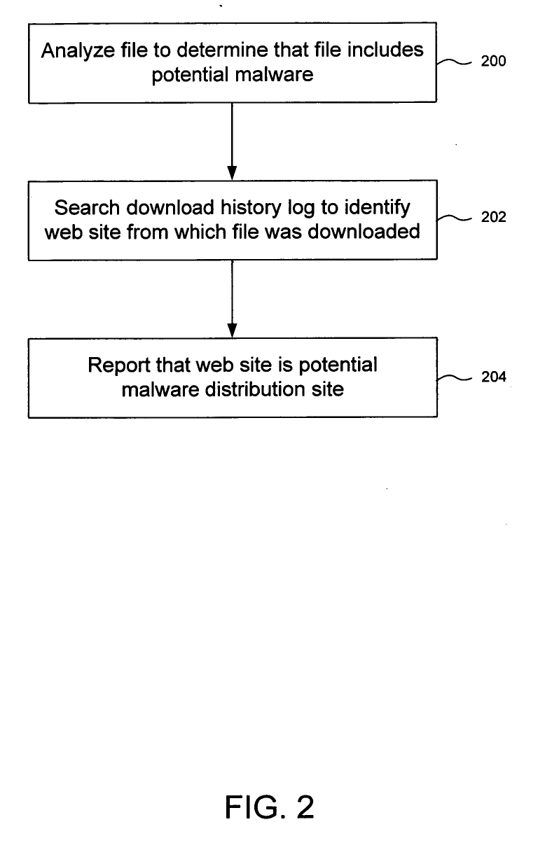

The foregoing provides a general overview of an embodiment of the invention. Attention next turns to FIG. 2, which illustrates a flowchart for identifying a malware distribution site, according to an embodiment of the invention.

The first operation illustrated in FIG. 2 is to analyze a file to determine that the file includes potential malware (block 200). In the illustrated embodiment, a malware detection module (e.g., the malware detection module 118) scans files of a protected computer (e.g., the protected computer 102) to locate the file. The malware detection module can scan files of the protected computer on a periodic or some other basis. Alternatively, or in conjunction, operation of the malware detection module can be triggered based on determining that the file is being downloaded or has been downloaded using a Web browser (e.g., the Web browser 114).

In the illustrated embodiment, the malware detection module compares the file with a set of malware definitions to determine if the file includes potential malware. The set of malware definitions can include representations of malware, suspicious activities that are indicative of or that are common to malware, or both. For example, the set of malware definitions can include a hash value or a digital signature of malware, such as one that is generated using Message Digest 5 (“MD5”). In this example, the malware detection module generates a hash value for the file and compares the hash value of the file with a set of hash values of malware to determine whether there is a sufficient match. As another example, the set of malware definitions can include a Cyclical Redundancy Code (“CRC”) of a portion of malware. In this example, the malware detection module generates a CRC for the file and compares the CRC of the file with a set of CRCs of malware to determine whether there is a sufficient match. As a further example, the set of malware definitions can include suspicious activities related to third-party cookies or related to entries or modifications of registry files of an operating system.

The second operation illustrated in FIG. 2 is to search a download history log to identify a Web site from which the file was downloaded (block 202). In the illustrated embodiment, once the malware detection module determines that the file includes potential malware, a Web site identification module (e.g., the Web site identification module 120) accesses the download history log to identify the Web site from which the file was downloaded. The download history log serves to provide a record of downloading events. For example, the download history log can be a Web browser's history log (e.g., the history log 116). In this example, the Web site identification module can access the Web browser's history log to identify a Web address of the file. As described previously, the Web address of the file can be a URL of the file, which can have the following format: http://www.DomainName.com/Subdirectory/FileName.html, where “http://” specifies a communication protocol used to download the file, “www.DomainName” specifies a domain name of the Web site from which the file was downloaded, “/Subdirectory/” specifies a subdirectory within the Web site from which the file was downloaded, and “FileName.html” specifies a name of the file. Thus, by searching the Web browser's history log using the name of the file, the Web site identification module can identify the Web site from which the file was downloaded, such as in terms of the domain name of the Web site.

As another example, the Web site identification module can generate the download history log based on the Web browser's history log. In this example, the Web site identification module can access the Web browser's history log to extract salient information from the Web browser's history log, such as domain names of various Web sites and names of various files that were downloaded from the various Web sites. By including such salient information in the download history log, the Web site identification module can accelerate and simplify a search process. Further acceleration and simplification of the search process can be achieved by filtering out duplicative entries, such as in the event a same version of a file is downloaded multiple times from a Web site. It is also contemplated that the Web site identification module can generate the download history log independently of the Web browser's history log.

The third operation illustrated in FIG. 2 is to report that the Web site is a potential malware distribution site (block 204). In the illustrated embodiment, once the Web site identification module identifies the Web site, a reporting module (e.g., the reporting module 122) reports information regarding the Web site to a remotely-located computer that is connected to the protected computer. This information can identify the Web site as a potential malware distribution site, such as in terms of the domain name of the Web site. Alternatively, or in conjunction, this information can identify the file as including potential malware, such as in terms of the name of the file or the URL of the file. It is also contemplated that this information can include a representation of the file or can identify suspicious activities related to the file. This information as well as any additional relevant information can be analyzed at the remotely-located computer to determine whether the file does, in fact, include malware and whether the Web site is, in fact, a malware distribution site. If the Web site is determined to be a malware distribution site, a new or updated set of malware definitions can be generated based on content within the Web site, and the new or updated set of malware definitions can be provided to the protected computer. In addition, content within the Web site can be monitored on a periodic or other basis for new or updated malware. Also, a new or updated list of malware distribution sites can be generated so as to identify the Web site, and the new or updated list of malware distribution sites can be provided to the protected computer.

In the illustrated embodiment, the reporting module also alerts a user of the protected computer about the Web site. In particular, once the Web site identification module identifies the Web site, the reporting module alerts the user that the Web site is a potential malware distribution site. In addition, in the event the user subsequently visits the Web site or attempts to download the same or a different file from the Web site, the reporting module again alerts the user that the Web site is a potential malware distribution site. Alternatively, if the protected computer receives confirmation that the Web site is, in fact, a malware distribution site, the reporting module alerts the user accordingly.

It should be recognized that the embodiments of the invention described above are provided by way of example, and various other embodiments are contemplated. For example, with reference to FIG. 1, while the various modules 118, 120, 122, and 124 and the database 126 are illustrated as included in the protected computer 102, it should be recognized that such configuration is not required in all implementations. In particular, one or more of the various modules 118, 120, 122, and 124 and the database 126 can be included in a separate computer that is connected to the protected computer 102. Thus, for example, one or more of the various modules 118, 120, 122, and 124 and the database 126 can be included in a remotely-located computer that is included in the computer network 104.

An embodiment of the invention relates to a computer program product with a computer-readable medium including computer code or executable instructions thereon for performing a set of computer-implemented operations. The medium and computer code can be those specially designed and constructed for the purposes of the invention, or they can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute computer code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as generated by a compiler, and files including higher-level code that are executed by a computer using an interpreter. For example, an embodiment of the invention can be implemented using Java, C++, or other object-oriented programming language and development tools. Additional examples of computer code include encrypted code and compressed code. Moreover, an embodiment of the invention can be downloaded as a computer program product, which can be transferred from a remotely-located computer to a protected computer by way of data signals embodied in a carrier wave or other propagation medium via a transmission channel. Accordingly, as used herein, a carrier wave can be regarded as a computer-readable medium.

Another embodiment of the invention can be implemented using hardwired circuitry in place of, or in combination with, computer code. For example, with reference to FIG. 1, the various modules 118, 120, 122, and 124 can be implemented using computer code, hardwired circuitry, or a combination thereof.

While the invention has been described with reference to some embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while the methods described herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A method of neutralizing a malware process, comprising:
identifying a malware process;
accessing at least one function exported by said malware process; and
writing an instruction into the memory for said at least one exported function that renders said at least one exported function substantially ineffective.

2. The method of claim 1, wherein the accessing at least one function exported by said malware process comprises:
reading a memory address corresponding to said at least one export function;
populating a list with said at least one export function memory address; and
advancing through said list of at least one export function memory address to access said at least one export function.

3. The method of claim 1, wherein said instruction written into memory for each of said exported functions is a return instruction that causes each of said exported functions, when accessed by the malware process, to return without executing malware instructions within each respective exported function.

4. The method claim of claim 3, wherein said return instruction initiates a jump to a proper return value within the instructional code of said at least one export function.

5. The method of claim 1, wherein the identifying the malware process includes using a technique selected from the group consisting of a definition matching approach, a heuristics approach, and a dynamic offset scanning approach.

6. The method of claim 1, wherein said malware process is a dynamic link library.

7. The method of claim 1, wherein the identifying a malware process, accessing each function exported by said malware process, and writing, an instruction into the memory for each of said exported functions that renders each of said exported functions substantially ineffective are performed at a computer, the method further comprising:
deleting registry entries associated with said malware process; and
scheduling said malware process for deletion after the next reboot.
